(19) United States
(12) Patent Application Publication
(10) Pub. No.: US 2001/0056440 A1
(43) Pub. Date: Dec. 27, 2001

(54) Parallel execution mechanism for spreadsheets

(76) Inventors: David Abramson, Clayton (AU); Paul Roe, Brisbane (AU)

Correspondence Address: David P. Dureska, Esq., Buckingham, Doolittle & Burroughs, LLP, 4518 Fulton Drive, NW, P.O. Box 35548, Canton, OH, 44735-5548, US

(21) Appl. No.: 09/891,951

(22) Filed: Jun. 26, 2001

(30) Foreign Application Priority Data
Jun. 26, 2000 (AU) PQ8365

(51) Int. Cl. G06F 15/00

(52) U.S. Cl. 707/504; 707/905

(57) ABSTRACT

A method of implementing parallel execution of spreadsheet calculations in a conventional sequential spreadsheet by defining a custom function that passes arguments and a function identifier to an evaluation process that is run in parallel. Interim calculation results are stored in an evaluation table and final results are passed back to the spreadsheet.

The method can be embodied in an add-in that results in a decrease in the time necessary for a spreadsheet calculation.

The invention relates to a parallel execution mechanism for spreadsheets In particular, it relates to a method that implements parallel execution without modification to the spreadsheet sequential execution engine.

### BACKGROUND TO THE INVENTION

Spreadsheets are popular because they are easy to use and modify, and they support numerical data analysis without programming. A feature of modern spreadsheets is the capability to be extended with custom functions or add-ins. For example, spreadsheets are particularly useful for complex simulation functions and computational experiments. For these reasons, spreadsheets make an ideal vehicle for numerical simulations since they support pre and post processing of simulation data without the need for programming.

Because simulations are computationally intensive it is desirable to execute as many of them in parallel as possible. This has previously been recognized and it is known to use parallel evaluation of complex numerical simulations using custom designed evaluation software. Once such software package is known to the inventors by the trade name Nimrod and is described in Abramson D., Sosic R., Giddy J. and Hall B., “Nimrod: A Tool for Performing Parametised Simulations using Distributed Workstations”, The 4th IEEE Symposium on High Performance Distributed Computing, Virginia, August 1995

Using a spreadsheet offers advantages compared to custom products such as Nimrod due to the generic nature of spreadsheets and their near ubiquitous availability and acceptance. A good example is the Microsoft Excel® product.

Products such as Microsoft Excel® have a sequential processing engine and cannot directly implement a parallel processing mechanism without modification to the underlying processing engine. Modification of the underlying engine would result in a new product that would be very difficult to produce in a backwards compatible way. Thus modification of the processing engine is not a viable method of achieving parallel execution of calculations in known spreadsheet programs.

The desirability of enhanced calculations of formulas in spreadsheets has been recognized by Lotus Development Corporation. In U.S. Pat. No. 5,862,400, a formula coprocessor is described for known personal computers. The benefit of the coprocessor with spreadsheet applications is that the result of one or more formulas can be cached for repeated use within a spreadsheet calculation. This invention speeds up spreadsheet calculation by eliminating multiple sequential evaluation of common formulas in a spreadsheet. The patent is concerned with a hardware solution to spreadsheet performance rather than in providing a mechanism for achieving parallel execution of spreadsheet calculations. The calculations in the Lotus patent are still sequential but known solutions are used instead of recalculation.

### OBJECT OF THE INVENTION

It is an object of the invention to provide a method for parallel execution of at least some calculations in a spreadsheet.

Further objects will be evident from the following description.

### DISCLOSURE OF THE INVENTION

In one form, although it need not be the only or indeed the broadest form, the invention resides in a method of parallel execution of spreadsheet calculations including the steps of: defining custom functions that pass arguments and a function identifier to an evaluation process from a spreadsheet cell for parallel evaluation of said custom functions; constructing an evaluation table for storing interim and final results of said custom functions; returning interim results to said spreadsheet cells during a first evaluation cycle; forcing reevaluation of said spreadsheet cells; and returning final results from said evaluation table to said spreadsheet cells.

Further features of the invention will be evident from the following description.

### BRIEF DETAILS OF THE DRAWINGS

To assist in understanding the invention, preferred embodiments will now be described with reference to the following figures in which:

FIG. 1 shows schematically the concept of parallel execution of a calculation;

FIG. 2 shows how the calculation of FIG. 2 is represented in a spreadsheet;

FIG. 3 shows how the calculation of FIG. 1 can be performed using parallel execution with custom functions;

FIG. 4 shows an initial value of an evaluation table in the calculation;

FIG. 5 shows the spreadsheet after a first calculation;

FIG. 6 shows values in an evaluation table after a first calculation;

FIG. 7 shows the spreadsheet after a first round of calculations;

FIG. 8 shows the evaluation table at completion of calculations;

FIG. 9 shows the spreadsheet at the completion of the calculation; and

FIG. 10 shows a computer environment suitable for implementation of the invention.

### DETAILED DESCRIPTION OF THE DRAWINGS

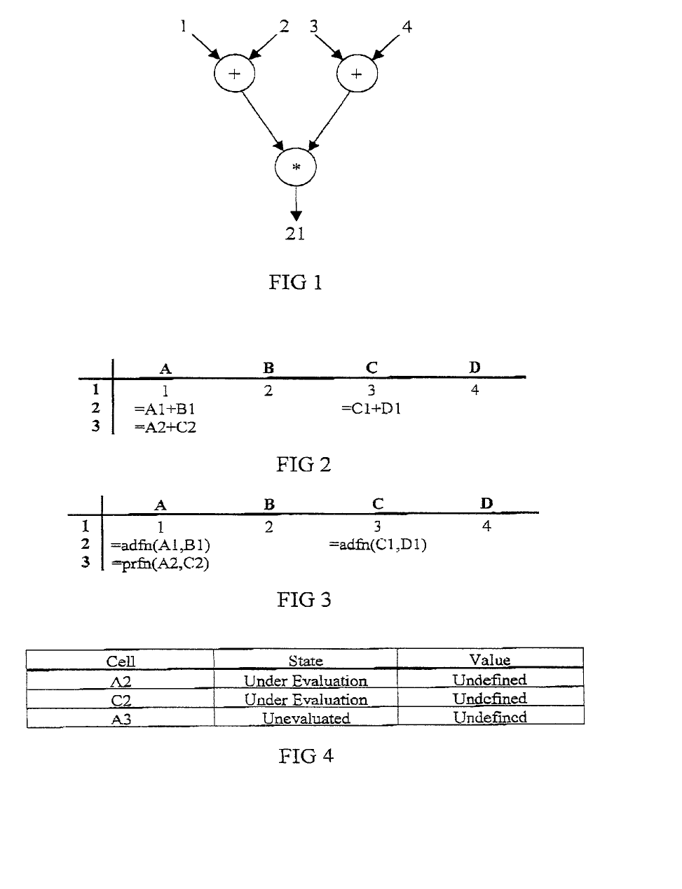

In the drawings, like reference numerals refer to like parts. In FIG. 1 there is shown a parallel depiction of the calculation (1+2)*(3+4). The result of the calculation is obviously 21. In the figure the nodes 1 represent operators. Once an operator has the required number of arguments it may be evaluated to generate a result which is output, possible to a next operator. The evaluation may be viewed as data flowing along arcs between operators.

Evaluation is sequential if the first operation is evaluated and the result stored, followed by the second operation being evaluated with the result stored and finally the third operation being evaluated using the result from the two earlier calculations.

In contrast the calculation can be performed far more efficiently in a parallel fashion if the initial two operations are evaluated concurrently followed by evaluation of the third operation The depiction of the calculation in a standard spreadsheet, such as Microsoft Excel® is shown in FIG. 2 In the standard spreadsheet each cell is evaluated sequentially. Thus if a number is changed in the first row of the spreadsheet each cell is reevaluated to obtain the changed result. In practice, the spreadsheet engine only evaluates cells which have changed since the last evaluation and any cell that depends on the changed cell. In a large spreadsheet this can be a very slow process.

Parallel evaluation of the formula in the spreadsheet can be achieved by defining custom functions, or add-ins, that work with the built-in spreadsheet functions. For the purpose of explaining the invention, two simple functions will be defined. The first function adfn(a,b) adds the arguments a and b. The second function prfn(a,b) gives the product of the arguments a and b. It should be appreciated that these functions are only for the purpose of example, in practice custom functions would not be defined for such simple functions, and might well involve the execution of a program external to the spreadsheet program itself.

In order to evaluate an otherwise sequential spreadsheet in parallel a two stage evaluation process is adopted. In the first step the custom function sends its arguments together with a representation of the function to an evaluation process for parallel evaluation. An evaluation table is used to store the current state of the cell. The cell will be either unevaluated, under evaluation or evaluated.

The evaluation process may distribute the calculation to any number of processors, either within the same machine or externally, for evaluation. Mean time, the custom function returns an error or undefined value to the spreadsheet cell which prevents the spreadsheet from interpreting the cell as holding a valid value. By returning an error value immediately, the spreadsheet will continue sequential evaluation without waiting for the result of the custom function. This means that other custom functions in other cells can be evaluated by the same process. The spreadsheet will therefore complete a sequential evaluation cycle much more quickly than usual. In the mean time, the evaluation process evaluates the custom functions and stores the result in an evaluation table.

In the second step, the spreadsheet is forced to make a reevaluation. The error values in the spreadsheet are replaced by the values stored in the evaluation table by the evaluation process.

The cycles are repeated until all functions have been evaluated and there are no more changes in the spreadsheet.

The simple calculation shown in FIG. 1 will be used as the basis of an example of the manner in which the invention may be put into effect. FIG. 3 shows the spreadsheet of FIG. 2 configured for parallel evaluation. The built-in functions used in FIG. 2 have been replaced by custom functions in FIG. 3. As mentioned above, custom functions would not replace built-in functions. Custom functions will be more complicated. Nonetheless, the simple example serves to explain the principle of the invention. In general, the custom functions may be arbitrary executable programs which happen to take some parameters and return a result which can be stored in a spreadsheet cell.

Persons skilled in the use of spreadsheets will realise that functions in cells A2, C2 and A3 will normally appear in a formula box with the function values appearing in the spreadsheet cells.

The spreadsheet starts by evaluating, for example, cell A2. The custom function adfn makes an “under evaluation” entry in the evaluation table to indicate that it is being evaluated. The functions arguments and its identifier are sent to the evaluation process for parallel evaluation. The function returns an undefined value to the spreadsheet. The spreadsheet has a value in the cell and therefore continues to sequentially evaluate cells. The custom function in cell C2 also makes an “under evaluation” entry in the evaluation table and returns an undefined value to the spreadsheet.

The custom function prfn requires the values from cells A2 and C2. It therefore makes an “unevaluated” entry in the evaluation table but returns an undefined value to the spreadsheet to allow the spreadsheet to continue with sequential evaluation.

The evaluation table at the end of the first evaluation cycle by the spreadsheet is shown in FIG. 4. The spreadsheet appearance is shown in FIG. 5.

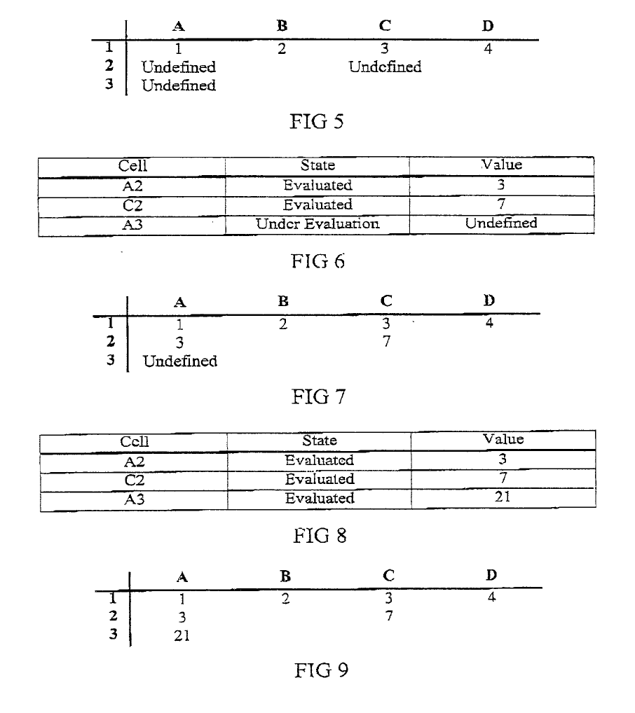

Evaluation of the custom functions occurs in parallel in the background. After evaluation of the custom functions the evaluation table will contain the function values as shown in FIG. 6.

The spreadsheet is then forced to perform a reevaluation. Upon reevaluation of the custom functions the values from the evaluation table will be returned so that the spreadsheet has the appearance shown in FIG. 7. Because the values in cells A2 and C2 have changed the spreadsheet will automatically reevaluate. By this time the parallel evaluation of the custom functions will have proceeded further so that the prfn function has been evaluated and the result stored in the evaluation table, as shown in FIG. 8. The value for A3 will be returned to the spreadsheet when the spreadsheet seeks to evaluate the cell and the final result shown in FIG. 9 will be obtained.

In many cases the parallel evaluation of the custom functions will be completed before the commencement of the second cycle of evaluation by the spreadsheet. In this case, the spreadsheet will not show the values shown in FIG. 7. The evaluation table will have all of the values as shown in FIG. 8 so the second evaluation cycle by the spreadsheet will result in the spreadsheet of FIG. 9.

It will be appreciated that this simple example would require three evaluation cycles under sequential evaluation Using the invention to achieve parallel evaluation, only two evaluation cycles are required. More importantly, the sequential evaluation does not wait for the result of a calculation before continuing the cycle The inventors have found that this results in a considerable decrease in the time taken to evaluate a spreadsheet. The greater the degree of “parallelism” of the spreadsheet, the greater the improvement. Furthermore, it will be appreciated that if a spreadsheet has a high degree of parallelism, in other words a lot of cells that can be evaluated in parallel, multiple processors will provide an even greater improvement

A number of techniques can be used to force the spreadsheet to perform a reevaluation. The technique used may be different for different spreadsheet products. There are three basic techniques The first technique is to rely on the automatic evaluation process built-in to most spreadsheet programs. An automatic evaluation occurs whenever a cell value changes. Thus simply changing the cell content each cycle will suffice because the spreadsheet engine will force a re-evaluation.

Another approach is to use command evaluation in spreadsheets where this facility is available. If a spreadsheet can be commanded to perform a complete reevaluation of all cells, the facility can be activated when the evaluation table shows all cells as having been evaluated,

Some spreadsheets can be commanded to reevaluate but only reevaluate cells that have changed since the last evaluation cycle. In this case the cell characteristics can be defined so that the cell reevaluates every cycle.

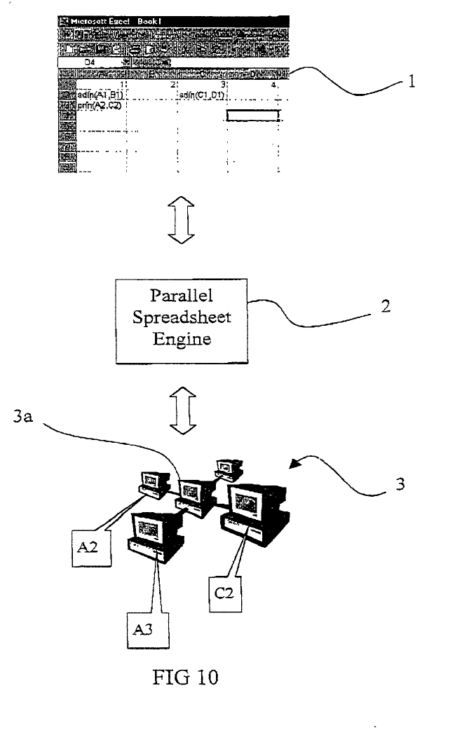

A computer environment suitable for working the invention is depicted in FIG. 10. A conventional spreadsheet program 1, such as Microsoft Excel® runs on a primary processor that is suitably a standard personal computer 3a. A parallel spreadsheet engine 2 also runs, at least in part, on the same personal computer. The personal computer 3a is part of a network 3 consisting of other processors, which may be similar personal computers, or perhaps servers having higher processing power. The parallel spreadsheet engine 2 detects and distributes the processing of the custom functions to other processors. Each processor has associated memory for storing the interim results of the evaluation of the custom functions before returning the final results to the spreadsheet 1.

At least the primary processor 3a has a display means to display the spreadsheet 1 throughout the calculation. Timing control for the evaluation cycles is also provided from the primary processor

The invention operates with known sequential execution spreadsheets to provide improved performance through parallel evaluation for custom functions. Although a custom parallel evaluation spreadsheet can be designed, it is much more economic to provide an add-in for available spreadsheets.

Throughout the specification the aim has been to describe the preferred embodiments of the invention without limiting the invention to any one embodiment or specific collection of features

1. A method of parallel execution of spreadsheet calculations including the steps of:
defining at least one custom function that passes arguments and a function identifier to an evaluation process from a spreadsheet cell for parallel evaluation of said custom function;
constructing an evaluation table for storing interim and final results of said custom function;
returning said interim result to said spreadsheet cell during a first evaluation cycle;
forcing reevaluation of said spreadsheet cell; and
returning said final result from said evaluation table to said spreadsheet cell.

2. The method of claim 1 wherein the evaluation process distributes the calculation to one or more processors.

3. The method of step 1 wherein the interim result may have states of under evaluation, unevaluated or evaluated.

4. The method of step 1 wherein the interim result may have a value of undefined when a state of the interim result is under evaluated or unevaluated.

5. The method of claim 1 wherein the step of returning interim results to said spreadsheet cell displays an error in said spreadsheet cell when a value of said interim result is undefined.

6. The method of claim 1 wherein there are multiple custom functions and the method is repeated until all custom functions are evaluated.

7. The method of claim 1 wherein the custom function is an arbitrary executable program which takes parameters from the spreadsheet cell and returns the final result to the spreadsheet cell.

8. The method of claim 1 wherein the step of forcing reevaluation of said spreadsheet cell uses a technique selected from built-in automatic re-evaluation, command complete re-evaluation, or command partial re-evaluation.

9. A parallel execution apparatus for spreadsheet calculations comprising:
means for storing and processing a spreadsheet of multiple spreadsheet cells. at least one said cell containing a custom function;
means for evaluating said custom function;
means for storing interim and final results of the evaluation of said custom functions;
means for displaying said interim result during a first cycle and said final result during a later cycle; and
timing means for determining said first and said later cycle.

10. A computer of the form having one or more processors, timing means associated with said processors, memory means for storing results of calculations, and display means. when programmed to perform a parallel execution process including the steps of:
defining at least one custom function that passes arguments and a function identifier to an evaluation process from a spreadsheet cell for parallel evaluation of said custom function;
constructing an evaluation table in said memory means for storing interim and final results of said custom function;
returning said interim result to said spreadsheet cell during a first evaluation cycle controlled by said timing means;
forcing reevaluation of said spreadsheet cell; and
returning said final result from said evaluation table to said spreadsheet cell for display on said display means.
